(19) United States
(12) Patent Application Publication
(10) Pub. No.: US 2004/0267780 A1
(43) Pub. Date: Dec. 30, 2004

(54) System for managing a component

(75) Inventors: Howard Shelton Lambert, Southampton (GB); James Ronald L. Orchard, Eastleigh (GB); Gillian Laura Woodcock, Fareham (GB); Steven Wright, Upham (GB)

Correspondence Address: IBM Corporation, IP Law Department, 11400 Burnet Road, Austin, TX, 78758, US

(73) Assignee: International Business Machines Corporation, Armonk, NY

(21) Appl. No.: 10/698,173

(22) Filed: Oct. 30, 2003

(30) Foreign Application Priority Data
Jun. 26, 2003 (GB) 0314904.4

(51) Int. Cl. G06F 7/00

(52) U.S. Cl. 707/100

(57) ABSTRACT

A system for managing at least one parameter associated with a first component (e.g. a process, a device, an application program etc.). The at least one parameter comprises at least three values corresponding to a minimum value and a maximum value together representing a range and a variable value. The system further comprises a data structure having data associated with the at least one parameter, means for accessing the data structure, means for monitoring the variable value, and means, responsive to the variable value lying within the range, for managing the at least one parameter.

### FIELD OF INVENTION

The present invention relates to a system for managing a component.

### BACKGROUND OF INVENTION

Consumer devices (e.g. mobile telephones, Personal Digital Assistants (PDAs) etc.) are becoming more and more popular. Furthermore, with the convergence of devices {e.g. mobile phones providing PDA capabilities and vice versa) I the ability to run more sophisticated applications on the devices is increasing.

Users are becoming dependent on their devices and therefore expect a level of reliability and stability from their devices. At the same time, many users of these devices do not have the skills to make decisions about performance tuning, problem resolution etc. and in any case, users do not want to get involved in maintenance of their devices.

Therefore, there is a need for a mechanism that allows devices to be simple to use, with little maintenance required by the user. There is also a need for a mechanism that allows a component (e.g. an application) to be managed without causing disruption to the normal running of the device.

### SUMMARY OF INVENTION

According to a first aspect, the present invention provides a system for managing at least one parameter associated with a first-component, wherein the at least one parameter comprises at least three values corresponding to a minimum value and a maximum value together representing a range and a variable value, the system comprising: a data structure comprising data associated with the at least one parameter, means for accessing the data structure, means for monitoring the variable value, and means, responsive to the variable value lying within the range, for managing the at least one parameter.

Preferably, the at least one parameter represents a resource associated with the system (e.g. memory attributes, security attribute, CPU attributes etc.). In a preferred embodiment, the system further comprises means, responsive to the variable value lying outside the range, for invoking an action. In one embodiment, the action comprises a re-launch of the first component.

Aptly, there is provided means for updating the data structure with the data, when the first component is launched. More aptly, a second component comprises the means for accessing, the means for monitoring and the means for managing. Still more aptly, the system comprises means for notifying the second component of events associated with the first component.

In a preferred embodiment, the system comprises means for initialising the parameter, wherein upon initialisation, the variable value represents an initial value. Preferably, when the first component is launched, the variable value represents a current value. More preferably, the data structure further comprises data associated with whether the first component is a critical component. Still more preferably, the system further comprises means for engaging with a pervasive device (e.g. a PDA, a mobile telephone etc.).

Advantageously, the present invention allows parameters associated with a component as defined at install time to be exploited, to provide a level of component management. Beneficially, users do not need to become heavily involved in the process.

It should be understood that the component can be a device, application program, process, service etc. It should be understood that the parameters represent parameters that govern the component's running characteristics (e.g. security attributes, compression attributes, display attributes etc.)

According to a second aspect, the present invention provides a method for use in a data processing system for managing at least one parameter associated with a first component, wherein the at least one parameter comprises at least three values corresponding to a minimum value and a maximum value together representing a range and a variable value, the system comprising a data structure having data associated with the at least one parameter, the method comprising the steps of: accessing the data structure, monitoring the variable value, and in response to the variable value lying within the range, managing the at least one parameter.

According to a third aspect, the present invention provides a computer program comprising program code means adapted to perform the method as described above when said program is run on a computer.

### BRIEF DESCRIPTION OF THE DRAWINGS

The present invention will now be described, by way of example only, with reference to preferred embodiments thereof, as illustrated in the following drawing:

FIG. 1 shows a system in which the present invention may be implemented.

### DETAILED DESCRIPTION OF THE INVENTION

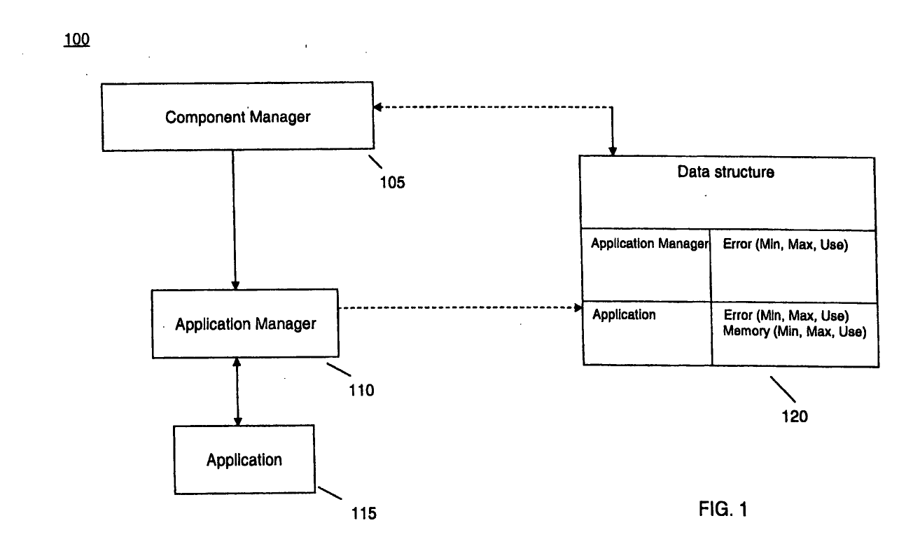

An overview of one system (100) in which the present invention may be implemented, is shown in FIG. 1. The system (100) comprises a component manager (105), a first component (i.e. an application manager (110)) and a second component (i.e. an application (115)). It should be understood that the application manager (110) is essentially another application in the system.

Preferably, the component manager (105) is responsible for managing the operating environment in the system (100). The component manager (105) and the application manager (110) access a data structure (120) holding data associated with the application (115) and the application manager (110). The way in which the entities interact with each other and with the data structure (120) will now be described.

Preferably, the application manager (110) is responsible for applications (115) that are installed in the system (100) and it communicates with the component manager (105). Preferably, the application manager (110) is responsible for installing and launching an application (115), as well as updating data associated with an application (115) (as will be described later). Preferably, the system (100) comprises means for notifying the component manager (105) of various events associated with a component. For example, a component's start time; a component's end time; when a component abnormally ends.

Preferably, the data associated with a component is defined by the application developer. When a component is launched, the system (100) comprises means for updating the data structure (120) with the data associated with the component. Preferably, for an application (115), the application manager (110) updates the data structure (120) and for the application manager (110), the component manager (105) updates the data structure (120).

Preferably, the data comprises one or more parameters. Examples of parameters held in the data structure (120) include: security information (e.g. access rights); usage statistics and resource requirements (e.g. memory, CPU requirements). These can be thought of as Quality of Service parameters. Preferably, other pieces of data are also included in the data structure (120), namely, the component name, location of the component (e.g. disk location, URL address, etc.) and whether it has been registered as critical or not.

Each parameter is specified as a triplet of values, comprising a minimum value; a maximum value and a third value (i.e. a variable value) representing an initial value or a current value. It should be understood that the applicant envisages the scope of the term parameter to encompass any parameter that defines a component's running characteristics. It should also be understood that the values used herein are for example purposes only.

In a first example, parameters are associated with an application (115), namely memory (in Kbytes) and error. Preferably, before application launch time, each parameter is initialized. The parameter comprises a minimum value, a maximum value and a third value, representing an initial or ideal value.

Memory [Min]: =2;

Memory [Max]: =8;

Memory [Use]: =4;

Error [Min]: =0;

Error [Max]: =2;

Error [Use]: =0;

Now, the application (115) is launched and the application manager (110) informs the component manager (105) of the launch. At this stage, the third value is updated to a current (i.e. actual) value.

Preferably, the component manager (105) monitors (i.e. reads) the current value. In this example, the current value for memory is 5 and although the current value for memory does not match the initial value, the value lies within the bounds defined and the component manager (105) therefore allows the allocation of 5 Kbytes of memory to the application (115). Note, that the data associated with the memory parameter is updated to reflect the new current value.

Next, the current value for memory increases to 9, causing an action to be invoked, the action indicating that the current value lies outside of the bounds defined for that parameter. Preferably, the application (115) is then aborted by the component manager (105).

In one embodiment, the component manager (105) checks the data structure (120) in order to determine whether the application (115) is a critical application. If the application (115) has not been registered as critical, preferably, the component manager (105) does not take action. However, if the application (115) has been registered as critical, preferably the component manager (105) takes action. In one example, the component manager (105) checks to see whether it can fulfil the memory request (e.g. by freeing resource elsewhere). In the case where resources are not available, preferably, the component manager (105) invokes an action, the action indicating that a critical component cannot be started. In the case where resources are available, preferably, the component manager (105) calls the application manager (110) to re-launch the application (115) On re-launch, the current value of the memory parameter is updated to 9 and the current value of the error parameter is incremented by one, to indicate that an error has occurred.

In another embodiment, upon failure of an application (115), a further check is made, namely, if the current system clock time (e.g. 15:00) falls within the application's (115) run time (e.g. between 09:00-17:00). As described above, the component manager (105) is notified of the application's (115) run time (i.e. application start time; application end time). If the application (115) is critical and if the system clock time falls within the application's (115) run time, preferably, the component manager (105) calls the application manager (110) to re-launch the application (115) On re-launch, the third value of the error parameter is incremented by one, to indicate that an error has occurred. If the application (115) is not critical and if the system clock time does not fall within the application's (115) run time, preferably, the component manager (105) does not take action.

In a second example, a parameter is associated with the application manager (110), namely, error. In this example, the application manager (110) has also been registered as critical. Preferably, before launch time of the application manager (110), the parameter is initialized. For the parameter, a minimum acceptable value, a maximum acceptable value and a third value is specified. At this stage, the third value represents an initial or ideal value.

Error [Min]: =0;

Error [Max]: =1;

Error [Use]: =0;

Now, the application manager (110} is launched and the third value represents a current (i.e. actual} value. The parameter data in the data structure (120} is updated to reflect this, and the component manager (105} has access to this data. Preferably, the component manager (105} monitors (i.e. reads} the current value. In this example, the current value is 0, which is within the defined range and therefore processing continues.

Next, the current value is 2, causing the application manager (110) to fail because the current value lies outside of the bounds defined for that parameter. Preferably, notice of this abnormal termination is sent to the component manager (105) and because the current value lies outside of the bounds defined for that parameter, the component manager (105) preferably invokes an action, the action indicating that a critical component cannot be started.

Advantageously, the component manager (105) exploits parameters associated with a component as defined at install time, to provide a level of component management.

The present invention is preferably embodied as a computer program product for use with a computer system. Such an implementation may comprise a series of computer readable instructions either fixed on a tangible medium, such as a computer readable media, e.g., diskette, CD-ROM, ROM, or hard disk, or transmittable to a computer system, via a modem or other interface device, over either a tangible medium, including but not limited to optical or analog communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable media with accompanying printed or electronic documentation, e.g., shrink wrapped software, pre-loaded with a computer system, e.g., on a system ROM or fixed disk, or distributed from a server or electronic bulletin board over a network, e.g., the Internet or World Wide Web.

1. A system for managing at least one parameter associated with a first component, wherein the at least one parameter comprises at least three values corresponding to a minimum value and a maximum value together representing a range and a variable value, the system comprising:
a data structure comprising data associated with the at least one parameter,
means for accessing the data structure,
means for monitoring the variable value, and
means, responsive to the variable value lying within the range, for managing the at least one parameter.

2. A system as claimed in claim 1, wherein the at least one parameter represents a resource associated with the system.

3. A system as claimed in claim 1, further comprising means, responsive to the variable value lying outside the range, for invoking an action.

4. A system as claimed in claim 3, wherein the action comprises a re-launch of the first component.

5. A system as claimed in claim 1, further comprising means for updating the data structure with the data, when the first component is launched.

6. A system as claimed in claim 1, wherein a second component comprises the means for accessing, the means for monitoring and the means for managing.

7. A system as claimed in claim 7, further comprising means for notifying the second component of events associated with the first component.

8. A system as claimed in claim 1, further comprising means for initialising the parameter, wherein upon initialisation, the variable value represents an initial value.

9. A system as claimed in claim 1, wherein when the first component is launched, the variable value represents a current value.

10. A system as claimed in claim 1, wherein the data structure further comprises data associated with whether the first component is a critical component.

11. A system as claimed in claim 1, further comprises means for engaging with a pervasive device.

12. A method for use in a data processing system for managing at least one parameter associated with a first component, wherein the at least one parameter comprises at least three values corresponding to a minimum value and a maximum value together representing a range and a variable value, the data processing system comprising a data structure having data associated with the at least one parameter, the method comprising the steps of:
accessing the data structure,
monitoring the variable value, and
in response to the variable value lying within the range, managing the at least one parameter.

13. A method as claimed in claim 12, wherein the at least one parameter represents a resource associated with the system.

14. A method as claimed in claim 12, further comprising the step of invoking, in response to the variable value lying outside the range, an action.

15. A method as claimed in claim 14, wherein the action comprises a re-launch of the first component.

16. A method as claimed in claim 12, further comprising the step of updating the data structure with the data, when the first component is launched.

17. A method as claimed in claims 12, wherein the means for accessing, the means for monitoring and the means for managing are executed by a second component.

18. A method as claimed claim 17, further comprising the step of notifying the second component of events associated with the first component.

19. A method as claimed in claim 12, further comprising the step of initialising the parameter, wherein upon initialisation, the variable value represents an initial value.

20. A method as claimed in claim 12, wherein when the first component is launched, the variable value represents a current value.

21. A method as claimed in claim 12, wherein the data structure further comprises data associated with whether the first component is a critical component.

22. A method as claimed in claim 12, further comprising the step of engaging with a pervasive device.

23. A computer program comprising program code means adapted to perform the method of claim 12 when said program is run on a computer.
